(19) United States
(12) Patent Application Publication
(10) Pub. No.: US 2009/0200221 A1
(43) Pub. Date: Aug. 13, 2009

(54) LIQUID FILTER ARRANGEMENT AND METHOD

(75) Inventors: John R. Hacker, Minneapolis, MN (US); Brian Mandt, Shakopee, MN (US); Brent Gulsvig, Faribault, MN (US)

Correspondence Address: MERCHANT & GOULD PC, P.O. BOX 2903, MINNEAPOLIS, MN, 55402-0903, US

(73) Assignee: DONALDSON COMPANY, INC., Minneapolis, MN (US)

(21) Appl. No.: 11/911,701

(22) PCT Filed: May 6, 2005
(86) PCT No.: PCT/US2005/015820

§ 371 Date: May 28, 2008

Related U.S. Application Data
(60) Provisional application No. 60/672,696, filed on Apr. 18, 2005.

(51) Int. Cl. B01D 29/21; B01D 27/06; B23P 6/00

(52) U.S. Cl. 210/232; 210/457; 210/440; 29/402.08

(57) ABSTRACT

A filter element includes a tubular extension of pleated media, a first end cap, a second end cap, a porous-inner filter support oriented to line the pleated filter media, a latch arrangement, and a seal member. The inner filter support has an end wall adjacent to the first end cap, with the end wall defining an opening. The latch arrangement projects from the end wall of the filter support. The seal member is secured to the second end cap and circumscribes the second end cap aperture.

This patent application claims priority to U.S. Provisional Patent Application 60/______ filed Apr. 18, 2005. The complete disclosure of Application 60/______ is incorporated herein by reference in its entirety.

### TECHNICAL FIELD

This application describes filter arrangements. In particular, this application describes a filter cartridge useable in a filter bowl for purifying liquids, such as oil for engines.

### BACKGROUND

Filters are commonly used in connection with lubrication systems and fuel systems for internal combustion engines, and hydraulic systems for heavy-duty equipment. Filters are also used in many other types of liquid systems. In these types of systems, the filter is changed periodically. In the art, there are at least two standard types of filters used. One type is a spin-on canister filter, while the other is a bowl-cartridge filter. This application addresses bowl-cartridge filters.

Bowl-cartridge filters typically include a reusable bowl (or service cover) holding a replaceable filter element (cartridge filter). Bowl-cartridge filters are mounted onto a filter head or filter base, wherein liquid to be cleaned passes through the filter head (base), into the bowl (service cover), through the replaceable cartridge filter, outside of the bowl (service cover), and back into the filter head (base). After a period of use, the bowl-cartridge filter is removed from the filter head (base), and the replaceable cartridge filter is removed from the reusable bowl (service cover). The old cartridge filter is discarded with a new cartridge filter. The new cartridge filter is operably mounted into the reusable bowl (service cover) to provide a refurbished bowl-cartridge filter. This refurbished bowl-cartridge filter containing the new cartridge filter, is then mounted onto the filter head (base).

### SUMMARY

A filter element is provided including a tubular extension of pleated media, a first end cap, a second end cap, a porous-inner filter support oriented to line the pleated filter media, a latch arrangement, and a seal member. The inner filter support has an end wall adjacent to the first end cap, with the end wall defining an opening. The latch arrangement projects from the end wall of the filter support. The seal member is secured to the second end cap and circumscribes the second end cap aperture.

### BRIEF DESCRIPTION OF THE DRAWINGS

FIG. 1 is a perspective, cross-sectional view of a first embodiment of a filter element constructed according to principles of this disclosure;

FIG. 2 is an exploded, perspective view of the filter element depicted in FIG. 1;

FIG. 3 is a cross-sectional, perspective view of a second embodiment of a filter element constructed according to principles of this disclosure;

FIG. 4 is an exploded, perspective view of the filter element depicted in FIG. 3;

FIG. 5 is a cross-sectional, perspective view of a third embodiment of a filter element constructed according to principles of this disclosure;

FIG. 6 is an exploded, perspective view of the filter element depicted in FIG. 5;

FIG. 7 is a schematic, cross-sectional view of a filter base and filter bowl that can receive any of the filter elements of FIGS. 1-6; and

FIG. 8 is a perspective, cross-sectional view of an alternative embodiment of the filter element of FIGS. 1 and 2.

### DETAILED DESCRIPTION

This application describes filter elements that are useable within a reusable service cover for mounting onto a filter base. The filter elements are useable in assemblies that can be used in a “top-load” orientation. By the term “top-load”, it is meant that the filter assembly (filter base plus the service cover with the filter element operably installed therein) is installed in an orientation that permits servicing or access to the filter assembly from a position over or above whatever part that remains fixed to the equipment (e.g., engine, or generator, or whatever is the applicable machine part) in operational position during servicing, when the equipment is in normal, operable orientation. In many convenient top-load configurations, the person servicing the filter assembly is not required to be in a position underneath or below the equipment. Instead, the person servicing the filter assembly is able to access it from the top of the equipment. For example, in a vehicle having an engine that is selectively accessible by a moveable hood, the filter assembly would be accessible merely by raising the hood of the vehicle and then removing the service cover.

One example of a filter assembly in a top-load configuration having a service cover and a filter head is described in U.S. Pat. No. 5,770,054, incorporated herein by reference. U.S. Pat. No. 5,770,054 also has a bypass valve located therein.

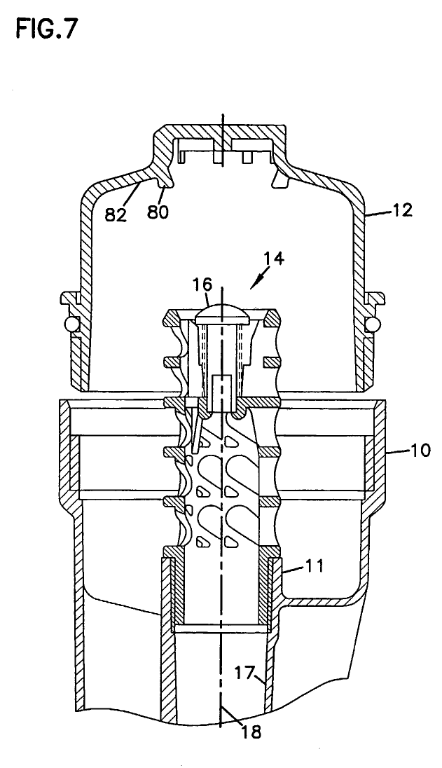

FIG. 7 illustrates one embodiment of a filter base 10 and a service cover 12. The service cover 12 is removably mountable on the filter base 10. Extending through the center of the filter base 10 is a bypass valve assembly 14. The valve assembly 14 includes a moveable valve head 16, which is operably assembled to move along the longitudinal axis 18 when a filter element is operably mounted in the filter base 10 and the cover 12 is properly mounted for use. The valve head 16 urges against a portion of the filter element to create a seal when the filter element is properly mounted for use in the filter base 10 and the service cover 12 is arranged.

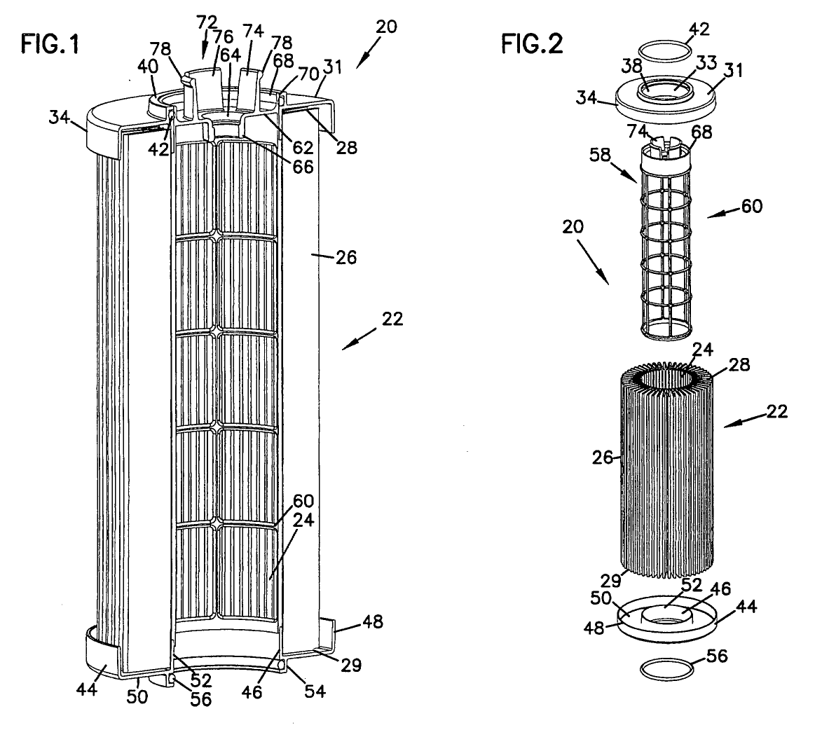

In reference now to FIGS. 1 and 2, a first embodiment of a filter element mountable in the filter base 10 is illustrated generally at 20. In the embodiment shown, the element 20 includes a tubular extension of filter media 22 defining an open filter interior 24. The open interior 24 is provided to be able to receive the valve assembly 14 therewithin. In the embodiment shown, the filter media 22 is pleated filter media 26.

The pleated media 26 defines first and second opposite ends 28, 29. In the embodiment shown, the filter element 20 further includes a first end cap 31 secured to the first end 28 of the pleated media 26. The first end cap 31 defines an open aperture 33. Of course, many embodiments are contemplated, and in the particular embodiment shown, the first end cap 31 is defined by an outer peripheral wall generally orthogonal to a planar region 36. Defining the aperture 33 and generally orthogonal to the planar region 36 is an inner wall 38. Projecting from the planar wall 36 is a C-shaped projection 40. The C-shaped projection 40 holds a seal member 42 for forming a seal with another portion of the filter element 20. This is described further below.

Still in reference to FIGS. 1 and 2, the filter element 20 further includes a second end cap 44 secured to the second end 29 of the pleated media 26. The second end cap 44 defines a second end cap aperture 46, which is in communication with the open filter interior 24. While a number of different configurations of end caps 44 are contemplated, in the particular one shown, the end cap 44 includes an outer peripheral wall 48, generally orthogonal to a planar region 50, and an inner wall 52, generally orthogonal to the planar region 50 and defining the aperture 46. Projecting from the planar region 50 is a C-shaped projection 54 holding a seal member 56. The seal member 56 circumscribes the aperture 46 and is oriented to form a seal with a portion of the filter base 10, when the element 20 is mounted on the base 10.

In the embodiment shown, the filter element 20 further includes a porous, inner filter liner or support 58 oriented in the open filter interior 24 and lining the filter media 22. The filter support 58, in the embodiment shown, generally extends between the first end cap 31 and the second end cap 44. In the embodiment shown, the filter support 58 has a tubular grid 60 that lines the open interior 24 and provides support to the pleated media 26. The filter support 58 further includes an end wall 62 oriented adjacent to the first end cap 31. The end wall 62 defines an opening 64. The opening 64 is in communication with the open filter interior 24.

Extending into the open filter interior 24 from the end wall 62 is a tubular neck 66. The tubular neck 66 circumscribes the opening 64 in the end wall 62. The neck 66 is used to press against the valve head 16 to form a seal between the neck 66 and the valve head 16, when the element 20 is operably oriented in the filter base 10 and the cover 12 is in place. In typical implementations, the neck 66 extends into the open filter interior 24 by a distance not greater than 12 mm, for example, at least 4 mm and not greater than 8 mm. When the restriction across the media 22 becomes high or in the case of a cold start or surge-flow condition, the valve head 16 will move vertically downwardly in the direction of the filter base 10 along the axis 18 away from the neck 66. This will open a volume and allow for liquid to bypass the media 22 and flow directly into the open filter interior 24.

Still in reference to FIGS. 1 and 2, the filter support 58 further includes a sealing wall 68 generally orthogonal to and at an outer periphery of the end wall 62. The sealing wall 68 is oriented relative to the C-shaped projection 40 and the seal member 42 to form a seal 70 therewith. That is, the seal 70 is formed between and against the sealing wall 68 and the C-shaped projection 40 of the first end cap 31.

In the embodiment shown, the filter element 20 further includes a latch arrangement 72 projecting from the end wall 62 of the filter support 58. In the embodiment shown, the latch arrangement 72 includes at least two latches, preferably four latches 74. Each of the latches 74 includes a deflectable latch finger 76 secured to the end wall 62 and a catch 78 at a free end of each finger 76. The latch arrangement 72 can be used to releasably secure the filter element 20 to the service cover 12. In FIG. 7, the service cover 12 has a ring 80 projecting from an inside surface 82 of the service cover 12. Each of the fingers 76 of the latches 74 deflects radially inwardly until the catch 78 snaps over the ring 80. This engagement removably attaches the element 20 to the service cover 12. In this manner, when the service cover 12 is removed from the base 10, the element 20 is removed with the service cover.

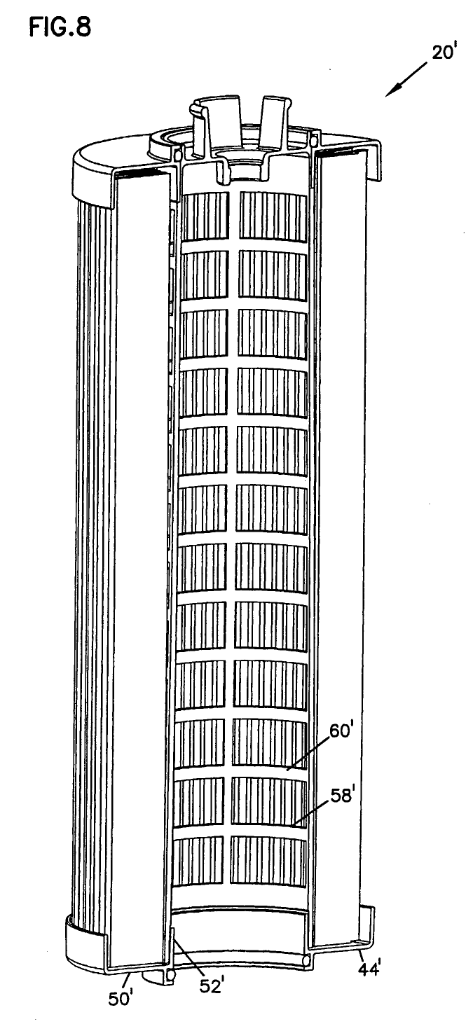

At an end of the filter support 58 remote from the end wall 62, the filter support 58 is secured to the second end cap 44, specifically, the inner wall 52 of the second end cap 44. In FIG. 8, an alternative way of securing the support 58′ to the inner wall 52′ for element 20′ is shown. In particular, the support 58′ extends to the planar surface 50′ of the end cap 44′. The inner wall 52′ overlaps the filter support 58′. FIG. 8 also depicts the filter support 58′ as having a denser grid 60′ than the element 20 of FIG. 1. Otherwise, the structure of element 20′ is the same as element 20.

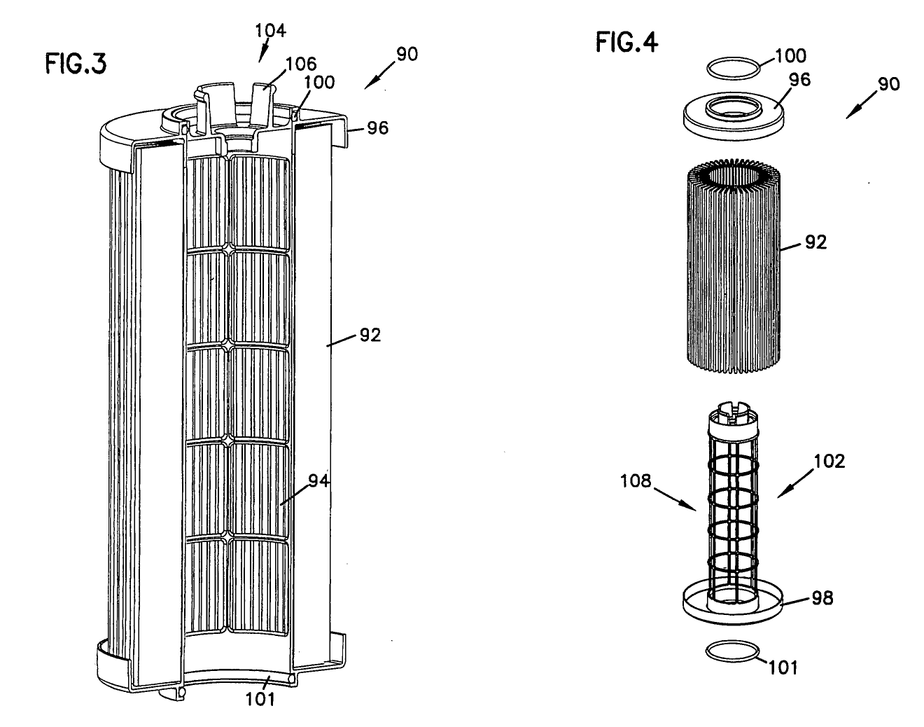

A second embodiment of the filter element is illustrated in FIGS. 3 and 4, generally at 90. The element 90 is generally analogous and has the features of the element 20, with some exceptions. The element 90 has media 92, an open interior 94, a first end cap 96, a second end cap 98, first and second seal members 100, 101, a filter support 102, and a latch arrangement 104 having latches 106. The only difference between the embodiment of FIGS. 3-4 and the embodiment of FIGS. 1-2 is that the filter support 102 and the second end cap 98 are a single, molded piece 108. Having the second end cap 98 and the filter support 102 be a single piece 108 can speed up assembly. Otherwise, each of the described features with respect to the embodiment of FIGS. 1 and 2 are incorporated herein by reference with respect to the features of FIGS. 3 and 4.

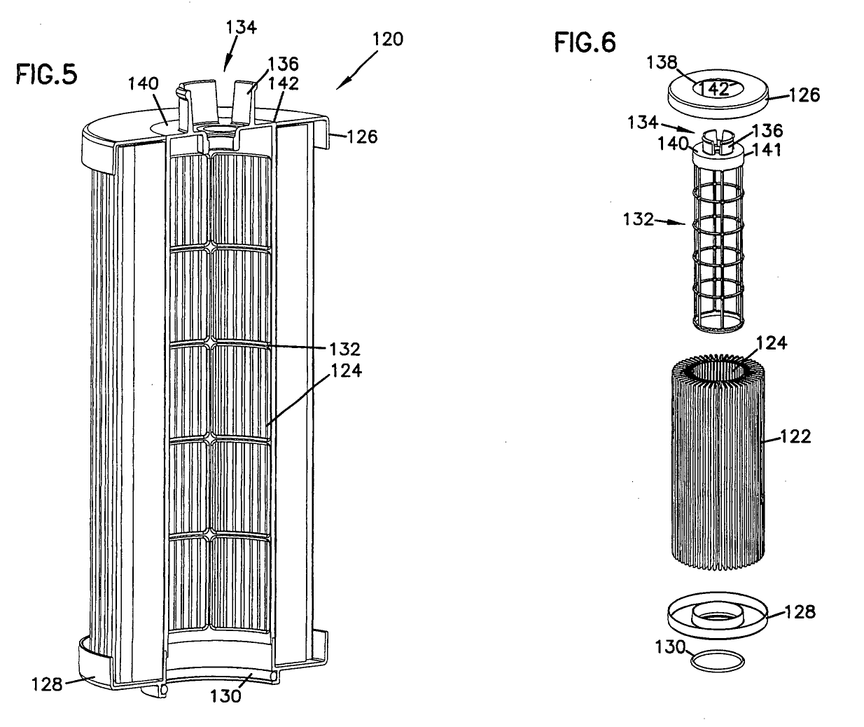

In reference now to FIGS. 5 and 6, a third embodiment of a filter element is illustrated at 120. The element 120 is generally analogous to the element 20 of FIGS. 1 and 2, with exceptions. The exceptions will be explained below. As with the element 20, the filter element 120 of FIGS. 5 and 6 include media 122, an open filter interior 124, a first end cap 126, a second end cap 128, a seal member 130, a filter support 132, and a latch arrangement 134 having latches 136.

The only difference between the embodiment of FIGS. 1-2 and the embodiments of FIGS. 5-6 is that the filter support 132 does not include a sealing wall 68, and there is no separate seal member 42 as with the embodiment of FIGS. 1-2. Instead, the filter support 132 is fit snugly (e.g., a line-to-line fit or a press fit) within the aperture 138 of the first end cap 126. The tight fit between the end wall 140 and the end cap 126 forms a seal 142 by pressure between a radial surface 141 (FIG. 6) of the end wall 140 and an inner rim 139 (FIG. 6) of the end cap 126. In addition, a potting compound can be used to secure the media 122 to the end cap 126, which also can help to form the seal 142.

In use, any of the filter elements shown in FIGS. 1-6 are useable in a filter assembly, including the type shown in FIG. 7. To service the filter assembly, the cover 12 is removed from the filter base 10. The existing filter cartridge or element is removed from the base 10, and a new element of the type shown in one of FIGS. 1-6 is provided. One of the filter elements of FIGS. 1-6 is oriented in the base 10, and a seal is formed between the seal member 56, 101, 130 and a portion 11 of the filter base 10. The cover 12 is then oriented over the element, and the latch arrangement 72, 104, 134 deflects and snaps into the ring 80. The neck 66 presses against the valve head 16 to form a bypass valve seal.

Fluid to be filtered enters through the filter base 10, from the outside of the filter media 22, 92, 122 and flows to the open filter interior 24, 94, 124. The filtered fluid then exits the open filter interior through the clean fluid flow passage 17 to exit the filter base 10.

Preferably, the filter elements described herein are made of non-metallic materials. In particular, the filter elements are at least 99% non-metallic, more preferably 100% non-metallic. In this manner, the filter elements are readily incineratable for disposal after use.

1. A filter element (20, 20′, 90, 120) comprising a tubular extension of pleated filter media (22, 92, 122) having first (28) and second (29) opposite ends; the tubular extension of pleated filter media defining an open filter interior (24, 94, 124); a first end cap (31, 96, 126) secured to the first end of the filter media; the first end cap having a first end cap aperture (33); a second end cap (44, 44′, 98, 128) secured to the second end of the filter media; the second end cap having a second end cap aperture (46) in communication with the open filter interior; a seal member (56, 101, 130) secured to the second end cap and circumscribing the second end cap aperture; the filter element being characterized by:
(a) a porous, inner filter support (58, 58′, 102, 132) oriented in the open filter interior and lining the pleated filter media;
(i) the inner filter support having an end wall (62) adjacent to the first end cap; the end wall defining an opening (64); and
(b) a latch arrangement (72, 104,134) projecting from the end wall of the filter support.

2. A filter element according to claim 1 further comprising:
a tubular neck (66) extending into the open filter interior from the end wall (62); the tubular neck circumscribing the opening in the end wall.

3. A filter element according to claim 2 wherein:
the inner filter support further includes a sealing wall (68) generally orthogonal to and at an outer periphery of the end wall.

4. A filter element according to claim 3 further comprising:
a seal (70) between the sealing wall (68) and the first end cap (31).

5. A filter element according to claim 1 wherein:
the latch arrangement includes at least two latches (74, 106, 136); each of the latches includes a deflectable latch finger (76) secured to the end wall (62) and a catch (78) at a free end of each finger.

6. A filter element according to claim 1 wherein:
the inner filter support (102) is a same molded piece as the second end cap (98).

7. A filter element according to claim 2 wherein:
the tubular neck (66) extends into the open filter interior by a distance of at least 4 mm and not greater than 8 mm.

8. A filter element according to claim 1 wherein:
the filter element is at least 99% non-metallic.

9. A filter assembly comprising a filter element according to claim 1; the filter assembly comprising:
a filter base (10);
the filter element operably mounted in the filter base; and
a service cover (12) operably and removably mounted over the filter base.

10. A filter element comprising:
(a) a tubular extension of pleated filter media having first and second opposite ends; the tubular extension of pleated filter media defining an open filter interior;
(b) a first end cap secured to the first end of the filter media; the first end cap having a first end cap aperture;
(c) a second end cap secured to the second end of the filter media; the second end cap having a second end cap aperture in communication with the open filter interior;
(d) a seal member secured to the second end cap and circumscribing the second end cap aperture;
(e) a porous, inner filter support oriented in the open filter interior and lining the pleated filter media;
(i) the inner filter support having an end wall adjacent to the first end cap; the end wall defining an opening;
(ii) a tubular neck extending into the open filter interior from the end wall; the tubular neck circumscribing the opening in the end wall;
(A) the tubular neck extending into the open filter interior by a distance of at least 4 mm and not greater than 8 mm;
(iii) a sealing wall generally orthogonal to and at an outer periphery of the end wall;
(f) a latch arrangement projecting from the end wall of the filter support;
(i) the latch arrangement includes at least two latches; each of the latches includes a deflectable latch finger secured to the end wall and a catch at a free end of each finger; and
(g) a seal between the sealing wall and the first end cap.

11. A filter element according to claim 10 wherein:
the inner filter support is a same molded piece as the second end cap.

12. A filter element comprising:
(a) a tubular extension of pleated filter media having first and second opposite ends; the tubular extension of pleated filter media defining an open filter interior;
(b) a first end cap secured to the first end of the filter media; the first end cap having a first end cap aperture;
(c) a second end cap secured to the second end of the filter media; the second end cap having a second end cap aperture in communication with the open filter interior;
(d) a seal member secured to the second end cap and circumscribing the second end cap aperture;
(e) an inner support having an end wall adjacent to the first end cap; the end wall defining an opening;
(i) a tubular neck extending into the open filter interior from the end wall; the tubular neck circumscribing the opening in the end wall;
(A) the tubular neck extending into the open filter interior by a distance of at least 4 mm and not greater than 8 mm; and
(f) a latch arrangement projecting from the end wall of the inner support;
(i) the latch arrangement includes at least two latches; each of the latches includes a deflectable latch finger secured to the end wall and a catch at a free end of each finger.

13. A filter element according to claim 12 wherein:
(a) the filter element is at least 99% non-metallic.

14. A filter element according to claim 12 wherein:
(a) the inner support includes a sealing wall generally orthogonal to and at an outer periphery of the end wall.

15. A filter element according to claim 14 further comprising:
(a) a seal between the sealing wall and the first end cap.

16. A filter element according to claim 12 wherein:
(a) the inner support includes a porous liner oriented in the open filter interior lining the pleated filter media.

17. A method of servicing a filter assembly; the method comprising:
(a) removing a cover from a filter base; the filter base having a valve assembly including a valve head;
(b) removing a filter element from the filter base;
(c) operably orienting a filter element made according to claim 12 in the filter base;
(d) orienting the cover over the filter element in the base;
(e) connecting the latch arrangement on the filter element with the cover; and
(f) pressing the tubular neck of the filter element against the valve head to form a bypass valve seal.

18. A method of servicing according to claim 17 wherein:
(a) the step of operably orienting a filter element in the filter base includes forming a seal between the inner support and the first end cap.

19. A method of servicing according to claim 17 wherein:
(a) the step of connecting the latch arrangement on the filter element with the cover includes deflecting the latch arrangement to snap onto a ring on the cover.

20. A filter assembly comprising:
a filter base;
a service cover (12) operably and removably mounted over the filter base; and
a filter element operably mounted in the filter base; the filter element including:
(a) a tubular extension of pleated filter media having first and second opposite ends; the tubular extension of pleated filter media defining an open filter interior;
(b) a first end cap secured to the first end of the filter media; the first end cap having a first end cap aperture;
(c) a second end cap secured to the second end of the filter media; the second end cap having a second end cap aperture in communication with the open filter interior;
(d) a seal member secured to the second end cap and circumscribing the second end cap aperture;
(e) an inner support having an end wall adjacent to the first end cap; the end wall defining an opening;
(i) a tubular neck extending into the open filter interior from the end wall; the tubular neck circumscribing the opening in the end wall;
(A) the tubular neck extending into the open filter interior by a distance of at least 4 mm and not greater than 8 mm; and
(f) a latch arrangement projecting from the end wall of the inner support;
(i) the latch arrangement includes at least two latches; each of the latches includes a deflectable latch finger secured to the end wall and a catch at a free end of each finger.
